(19) United States
(12) Patent Application Publication
(10) Pub. No.: US 2019/0255997 A1
(43) Pub. Date: Aug. 22, 2019

(54) IMAGING DEVICE FOR REARVIEW ASSEMBLY

(71) Applicant: GENTEX CORPORATION, Zeeland, MI (US)

(72) Inventor: Sebastien C. Jaeger, Saugatuck, MI (US)

(73) Assignee: GENTEX CORPORATION, Zeeland, MI (US)

(21) Appl. No.: 16/276,765

(22) Filed: Feb. 15, 2019

Related U.S. Application Data
(60) Provisional application No. 62/632,029, filed on Feb. 19, 2018.

(51) Int. Cl. B60R 1/00; B60R 1/12; B60R 1/04; B60R 11/02; H04N 5/225

(52) U.S. Cl. CPC B60R 1/00; B60R 1/12; B60R 1/04; B60R 11/0235; B60R 2011/0035; H04N 5/2254; H04N 5/2253; B60R 2001/1215; H04N 5/2252

(57) ABSTRACT

A rearview display for a vehicle comprises a housing comprising at least one of a lip and a bezel; at least one light diverter disposed in the housing; at least one lens disposed in the housing, the at least one lens configured to direct light to the light diverter; and an imager disposed in the housing and in optical communication with the at least one lens and the at least one light diverter.

### FIELD OF THE INVENTION

The present disclosure relates generally to a camera or imaging system for use in a vehicle and more particularly, to an imaging system configured to have a field of view of at least a portion of the interior of a vehicle, where the imaging system may be positioned within a rearview assembly or other interior vehicle location and have a low profile so it is not visually unappealing.

### BACKGROUND

Cameras and imaging devices are increasingly being employed for various functions in motor vehicles. Some of the imaging systems are to be used in the interior of a vehicle. They may be used, for example, to monitor vehicle occupants. Due to space and configuration restrictions, it may be difficult to have an unobtrusive imaging system with high quality video in the interior of a vehicle. The imaging systems may be difficult to disguise, and may be considered aesthetically displeasing.

### SUMMARY

According to an aspect of the disclosure, a rearview display for a vehicle may comprise a housing at least partially defining a cavity; at least one light diverter disposed in the housing; at least one lens configured to direct light to the light diverter; and an imager disposed in the housing and in optical communication with the at least one lens and the at least one light diverter. The at least one lens may be disposed either in the cavity or on a surface of the housing. The rearview display may further comprise a power supply in communication with the imager, and may be configured to provide power to the imager. The imager may comprise a processor. A power supply may be in communication with the imager. The power supply may be configured to provide power to the imager. The light diverter may be one of a mirror and a prism. The rearview display for a vehicle may be disposed in one of a rearview assembly, a pillar, a headliner, a vehicle dashboard, an instrument panel, a vehicle infotainment console, a heads-up display, and a visor of a motor vehicle. The rearview display for a vehicle may further comprise at least a second lens in optical communication with the at least one light diverter. The rearview display for a vehicle may further comprise at least a second light diverter in optical communication with the at least one light diverter and the imager. The imager may be one of a charge coupled device and a complementary metal-oxide semiconductor, and the imager may convert optical images to digital signals. The rearview display for a vehicle may further comprise a communication system, wherein images produced by the imaging system are transmitted through the communication system. The imager may be one of a charge coupled device and a complementary metal-oxide semiconductor; and the imager converts optical images to electronic signals. The imager may transmit images to at least one of a receiver exterior of the vehicle and a display element in the interior of the vehicle. The display element may be disposed on one of a rearview assembly, an A pillar, a visor, a heads-up display, and an infotainment console of a vehicle. The rearview display for a vehicle may further comprise an image stabilizer disposed to stabilize images captured by the imaging system.

The rearview display for a vehicle may further comprise a housing configured to optically isolate the at least one light diverter and the imager from ambient light. The rearview display for a vehicle may further comprise at least a second light diverter in optical communication with the imager. The second light diverter may be optically isolated from ambient light. When a second lens and a third lens are present, the second lens and the third lens may be optically isolated from ambient light. The rearview display may further comprise a barrier that at least partially defines a chamber from which ambient light is restricted. The first and second light diverters and the second and third lenses may be disposed within the chamber.

According to another aspect of the disclosure, an imaging system may comprise a first lens; a second lens; a first light diverter configured to direct light from the first lens to the second lens; a third lens in optical communication with the second lens; a second light diverter in optical communication with the third lens; an imager in optical communication with the second light diverter; and a housing enclosing at least the second lens, the third lens, the first light diverter, and the second light diverter; wherein light enters first light diverter from a first direction and is redirected to a second direction; and wherein light enters second light diverter from a second direction and is redirected to a third direction. The imaging system may be disposed in the interior of a vehicle. The imager may receive an optical image and transforms the optical image to a digital image. The imaging system may further comprise a communication system in communication with the imager; the communication system may transmit an image collected by the imaging system to at least one receiver. The first lens may be disposed in one of a lip and a bezel of a rearview assembly of a vehicle.

### BRIEF DESCRIPTION OF THE DRAWINGS

FIG. 1 illustrates a front view of a rearview assembly in accordance with the present disclosure:

FIG. 2 illustrates an exploded view of an embodiment of the rearview assembly of FIG. 1;

FIG. 3 illustrates a side view of a first embodiment of an imaging system in accordance with the present disclosure;

FIG. 4 illustrates a side view of a second embodiment of the imaging system:

FIG. 5 illustrates a side view of a third embodiment of the imaging system:

FIG. 6 illustrates a side view of a fourth embodiment of the imaging system.

### DETAILED DESCRIPTION

The present disclosure provides a camera or imaging system for the interior of a vehicle. The imaging system may have a field of view of at least a portion of the interior of the vehicle. The field of view may include a driver or other occupant of the vehicle, and the imaging system may provide for the acquisition of video or still images of a driver or other vehicle occupant. The imaging system may further may provide for the transmission of a continuous video stream or still images to at least one device within or outside of the vehicle. The exterior or visible portion of the camera or imaging system may have a low profile, and the portion of the imaging system that is not visible to a user may be configured to fit within an available space within a vehicle component with minimal or no unsightly exterior protrusions or extensions from the vehicle component in which the imaging system is disposed. In some embodiments, a lens may be the only portion of the imaging system visible to a user, and the rest of the system may be hidden within, for example, a rearview assembly or an A-pillar of the vehicle.

As used herein, a “rearview assembly” is a structure that may provide an image of a scene to the rear of a driver such rearview assemblies may include an electrochromic rearview assembly. Rearview assembly may alternatively include a simple prismatic mirror. Rearview assembly may additionally or alternatively include an electronic display element that displays an image as sensed by a rearward facing camera or other imaging system (see, for example, commonly assigned U.S. Pat. No. 6,550,949 entitled “SYSTEMS AND COMPONENTS FOR ENHANCING REAR VISION FROM A VEHICLE,” filed on Sep. 15, 1998, by Frederick T. Bauer et al., the entire disclosure of which is incorporated herein by reference). Additionally or alternatively, rearview assembly may include both an electrochromic rearview assembly and a display device for providing an image from a rearward facing camera or other imaging system.

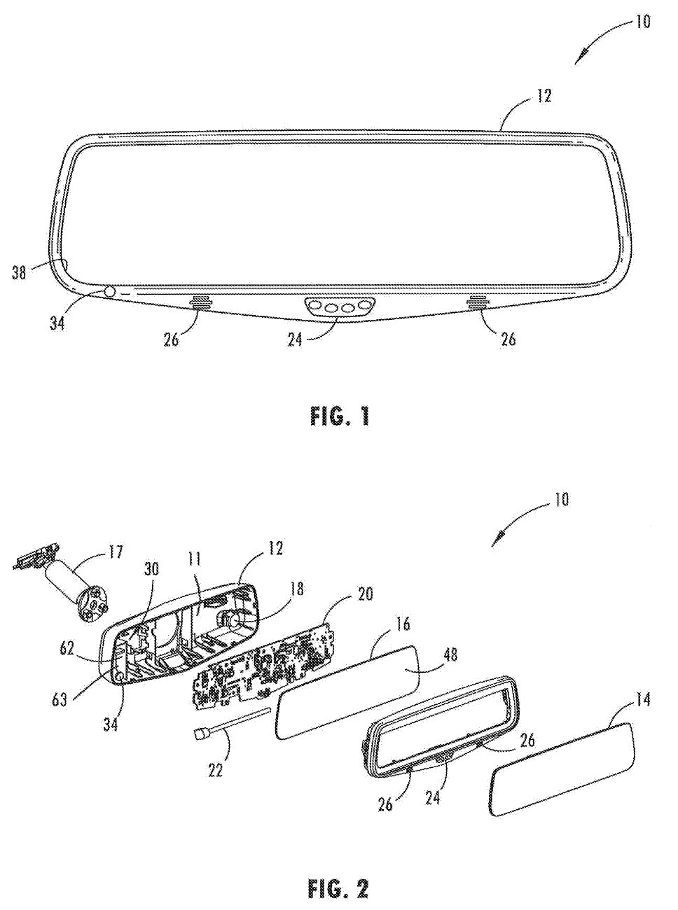

An example of a rearview assembly 10 is shown in FIGS. 1 and 2. Rearview assembly 10 may be designed for mounting directly to the vehicle windshield. Alternatively, rearview assembly 10 may be designed for mounting to a headliner or an interior portion of a roof of the vehicle. As will become apparent to one skilled in the art from the description of the various functions below, imaging system 30 and components of a vehicle communication system embodied in rearview assembly 10 may include various combinations of the elements identified below, and thus need not include each and every element shown and described. Further, although each of the elements may be housed within rearview assembly 10, some or all of the components may be provided in other remote locations and may transmit and receive information over a vehicle bus or via RF transmissions.

In general, rearview assemblies 10 include a housing 12 that may have a wide variety of possible designs, such as, for example, the mirror housing taught and claimed in U.S. Pat. No. 5,448,397. Rearview assemblies 10 may also include at least one of a rearview device 14 and a video display element 16, mounted in housing 12, and a mounting element 17 that attaches housing 12 to the vehicle. The various components described below may be mounted in housing 12 of rearview assembly 10 or may be mounted in mounting element 17, with appropriate electrical connections made therebetween. In some embodiments, rearview assembly 10 may include at least some components of a vehicle communication system, and the components of the vehicle communication system may comprise at least one of a speaker 26, a microphone 24, a camera or imager 18, and an RF antenna 22. The vehicle communication system may enable communication between vehicle occupants and users outside the vehicle.

FIG. 2 shows an exemplary mechanical construction of rearview assembly 10 having components of a vehicle communication system. The housing may at least partially define a cavity 11. As illustrated, the following components are mounted in or on housing 12: an optional rearview device 14; a display element 16; a printed circuit board 20 in communication with display element 16, and at least one RF antenna 22. At least one microphone 24 may be included. Rearview assembly 10 may also include at least one speaker 26. Rearview assembly 10 may further include at least one camera or other imaging device 18 disposed to capture a field of view exterior to the vehicle or may be in communication with at least one camera or other imaging system disposed to capture a field of view exterior to the vehicle. The vehicle communication system of rearview assembly 10 may be configured to transmit images to at least one of a display element in the vehicle such as display element 16 in rearview assembly 10 and a receiver external to the vehicle.

Display element 16 may be selectively activated, and may include a display screen or display surface 48 for the electronic display of images which may be transmitted from at least one camera 18 or other imaging systems. Rearview device 14 may comprise a partially reflective, partially transmissive element such as an electrochromic mirror. In some embodiments, rearview device 14 may be disposed in housing 12 in front of display element 16, thereby allowing display surface 48 to be viewable through the partially reflective, partially transmissive element 14 when display element 16 is activated.

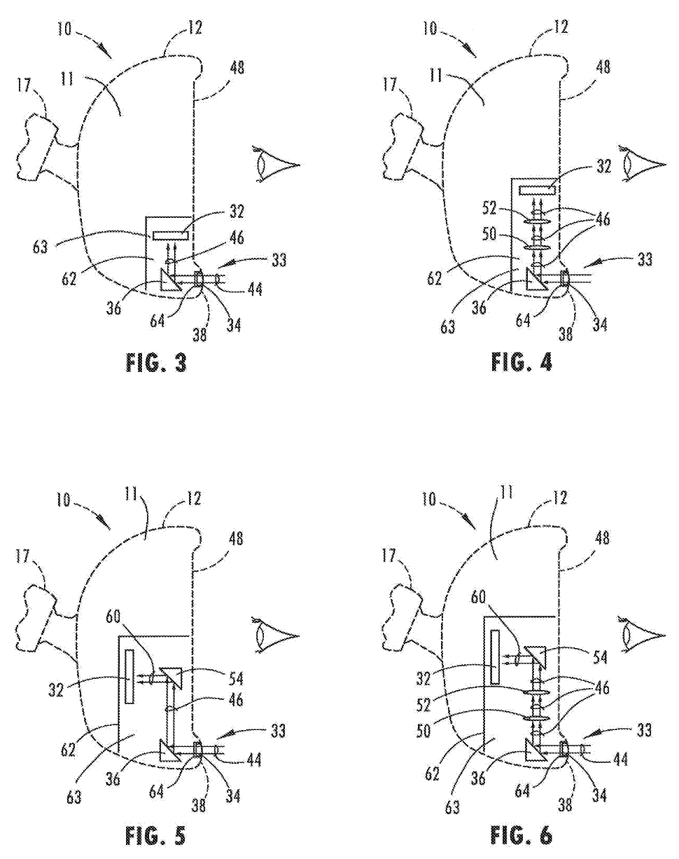

Referring now to FIG. 3, an embodiment of an imaging system for a vehicle is shown generally at 30. In some embodiments, Imaging system 30 may be disposed in vehicle rearview assembly 10. At least some components of imaging system 30 may be disposed behind rearview device 14, and may further be disposed between display surface 48 of display element 16 and housing 12 of display element 16. Imaging system 30 may include an imager 32, a lens system 33 comprising at least a first lens 34, and at least a first light deflector 36. In some embodiments, first lens 34 may be disposed in an inconspicuous location such as a lip 38 of housing 12 or in a bezel (not shown) of housing 12 of rearview assembly 10. This may allow lens and imaging system to be incorporated into rearview assembly 10 without requiring any change in the shape of housing 12 to accommodate imaging system 30. This may allow for a more aesthetically pleasing appearance. First lens 34 may be positioned to capture a field of view, such as a view of an occupant of the vehicle or of a portion of an interior of the vehicle.

In some embodiments, at least one additional lens 35 may be provided in lens system 33. The at least one additional lens 35 may be disposed between first lens 34 and first light deflector 36. The at least one additional lens 35 may be generally parallel to first lens 34.

Lens system 33 and first lens 34 of lens system 33 may be in optical communication with first light deflector 36. First light deflector 36 may be disposed within housing 12 of rearview assembly 10, and may be disposed to redirect the light coming from lens system 33. First light deflector 36 may comprise a prism or a mirror. Light may enter first light deflector 36 in a first direction 44, be deflected by light deflector 36, and exit first light deflector in a second direction 46 different from the first direction 44 from which it entered. In some embodiments, light may exit first light deflector 36 approximately 90 degrees from the angle at which it entered. In some embodiments, first direction 44 may be generally orthogonal to a display surface 48 of rearview assembly 10, and second direction may be generally parallel to display surface 48 of rearview assembly 10. In some embodiments, light leaving first light deflector 36 may be focused on imager 32.

Imager 32 may comprise a processor (not shown), and may be configured to capture and process images. In some embodiments, imager 32 may be disposed within housing 12, and in optical communication with first light deflector 36. In embodiments having a single light deflector or an odd number of light deflectors, imager 32 may be oriented to receive images traveling generally in second direction 46. In some embodiments. Imager 32 may comprise one of a charge-coupled device (CCD) or a complementary metal-oxide-semiconductor (CMOS) image sensor. Imager 32 may receive and process captured images, and the processor may convert optical images received from a lens or a light diverter into an electronic signal such as a digital signal. The captured images may be video images or may be one or more discrete still images. Images may be transmitted through wireless transmission capabilities of the vehicle communication system associated with rearview assembly 10, or rearview assembly 10 may be linked wired or wirelessly with a mobile telephone, and images may be transmitted through the mobile telephone network.

Referring now to FIG. 4, in some embodiments, imaging system 30 may have a plurality of lenses; for example, first lens 34, a second lens 50, and a third lens 52. First lens 34 may receive light 44 from the desired field of view and transmit it to first light deflector 36. Light may enter first light deflector traveling in first direction 44 and exit first light deflector 36 traveling in second direction 46 different from first direction 44 toward second lens 50. In some embodiments, the image being communicated may be changed in size by one or more lens 34, 50, 52. In some embodiments, second lens 50 may be in a spaced apart relationship with third lens 52. The image may travel from second lens 50 to third lens 52 in a direction generally parallel to display surface 48. This lens arrangement may allow second and third lenses 50, 52 to be spaced far enough apart to generate an image of an appropriate size and resolution, and still fit within housing 12 of rearview assembly 10 without requiring any extensions or protrusions in housing 12. Third lens may focus the image onto imager 32. Although three lenses are shown, this is for illustrative purposes only, and more or fewer lenses may be used without departing from the scope of this disclosure.

Referring now to FIG. 5, in some embodiments, imaging system 30 may have a plurality of light deflectors 36, 54. First lens 34 may receive an image traveling in a first direction 44 and communicate the image to first light deflector 36. First light deflector may change the direction of the incident light to a second direction 46 and communicate the image to a second light deflector 54. Second light deflector 54 may change the direction of the incident light to a third direction 60, and may send it to imager 32. In some embodiments, third direction 60 of light may be generally parallel to first direction of light 44. Imager 32 may be generally parallel to display surface 48 of rearview assembly 10. This may allow a larger imager 32 to be used without requiring any extensions or protuberances in housing 12 of rearview assembly 10. Images captured by imaging system 30 may be transmitted through the vehicle communication system of rearview assembly 10, utilizing the transmission capabilities of the vehicle communication system, such as RF antenna 22. Although two light deflectors are shown, this example is for illustrative purposes only and is not meant to be limiting. More or fewer light deflectors may be used and still be within the scope of this disclosure.

Referring now to FIG. 6, in some embodiments, imaging system 30 may have a plurality of light deflectors 36, 54 and a plurality of lenses 34, 50, 52. As shown, two light deflectors and three lenses are used, but more or fewer light deflectors and lenses may be used and still be within the scope of this disclosure. Light may enter imaging system 30 through first lens 34 traveling in a first direction 44. Light may then be communicated from first lens 34 to first light deflector 36. First light deflector 36 may redirect the incoming light so it leaves first light deflector 36 in a different direction 46 from the direction in which it entered 44. Upon leaving first light deflector 36, light may then pass through second lens 50 and third lens 52. Second and third lenses 50, 52 may be spaced apart from one another, and may change the size of the image and/or may focus the image. After exiting third lens 52, light may travel to second light deflector 54 which may deflect light in a third direction 60. In some embodiments, third direction 60 may be generally the same as or parallel to first direction 44 from which light entered first lens 34 of imaging system 30. After leaving second light deflector 54, light may reach imager 32. Imager 32 may transform the incoming light into a digital image. The vehicle communication system of rearview assembly 10 may then transmit the digital image for display. The digital image may be transmitted through wireless or Bluetooth® technology, or through a mobile network. The digital image may be transmitted to at least one of display screen 48 of display element 16 of rearview assembly 10 and an external receiver such as a mobile telephone, a tablet, a smart television, or a computer (not shown).

In some embodiments, a housing or barrier 62 may optically isolate the one or more light deflectors 36, 54 from ambient light in housing 12. Housing or barrier 62 may be opaque, and may prevent ambient light inside housing 12 from interfering with the transfer and capture of the image being processed by imaging system 30. Housing or barrier 62 may be configured to enclose the at least one light deflector 36, 54. Housing or barrier 62 may also enclose and optically isolate any lenses disposed between light deflectors 36, 54, or between first light deflector 36 and imager 32, including second and third lenses 50, 52. In some embodiments, housing or barrier 62 may extend from first lens 34 to imager 32. Imager 32 may be enclosed by housing or barrier 62 to be optically isolated from any ambient light. In some embodiments, housing or barrier 62 may at least partially define a chamber 63 from which ambient light is restricted. The one or more light deflectors 36, 54 and the one or more lenses 34, 50, 52 may be disposed within chamber 63.

In some embodiments, components of imaging system 30, such as any lenses 34, 50, 52, light deflectors 36, 54 and imager 32 may be disposed in different components or accessories or elsewhere in the interior of the vehicle, such as in a headliner or a visor of a vehicle, an A-pillar, a door panel, a heads-up display, a vehicle dashboard or instrument panel, a headrest, or a vehicle infotainment console.

In some embodiments, imaging system 30 may further comprise an image stabilizer 64. In some embodiments, image stabilizer 64 may be a digital image stabilizer. In some embodiments, image stabilizer may be an optical image stabilizer. Image stabilizer 64 may be associated with a lens 34, 50, 52 of imaging system 30.

In some embodiments, imaging system 30 disclosed herein may operate in conjunction with the communication system in a vehicle. The vehicle communication system may comprise both audio and video components. Components of the vehicle communication system may be located m proximity to imaging system 30; for example, imaging system 30 and some or all components of a vehicle communication system may be disposed within rearview assembly 10 of the vehicle. In some embodiments, portions of or the entirety of the vehicle communication system may be disposed in a separate location of the vehicle or disposed in different vehicle components or accessories than imaging system 30. Some components of imaging system 30 may be disposed in a location remote from other components. Certain aspects or components of the vehicle communication system may be implemented in a rear-view assembly, a headliner or visor of a vehicle, a heads-up display, an A-pillar, a door panel, a vehicle dashboard or instrument panel, a headrest, a vehicle infotainment console, or other locations within the interior of the vehicle.

Imaging system 30 may be in communication with the vehicle communication system, and the vehicle communication system may transmit the images captured by imaging system 30. A video stream or still image produced by imager 32 may be transmitted to a receiver external to the vehicle, be displayed on a surface in the interior of the vehicle, or both. In some embodiments, the images may be transmitted to and displayed on at least one of rearview assembly 10 and an external receiver such as a video-conferencing or video-chatting application on a mobile device, tablet, computer, or smart television. When displayed on display surface 48 of rearview assembly 10, image may extend across entire display surface 48 or may use only a portion of display surface 48.

It should be noted that references to “front,” “back,” “rear,” “inner.” “outer,” “right.” and “left” in this description are merely used to identify the various elements as they are oriented in the FIGURES. These terms are not meant to limit the element which they describe, as the various elements may be oriented differently in various applications.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

1. A rearview display for a vehicle comprising:
a housing at least partially defining a cavity;
at least one light diverter disposed within the cavity of the housing;
at least one lens configured to direct light to the light diverter; and
an imager disposed in the housing and in optical communication with the at least one lens and the at least one light diverter
wherein the at least one lens is disposed in the cavity or on a surface of the housing.

2. The rearview display for a vehicle of claim 1, wherein the imager comprises a processor.

3. The rearview display for a vehicle of claim 1, further comprising a power supply in communication with the imager.

4. The rearview display for a vehicle of claim 1, wherein the light diverter comprises one of a mirror and a prism.

5. The rearview display for a vehicle of claim 1, wherein the rearview display for a vehicle is disposed in one of a rearview assembly, a pillar, a headliner, a vehicle dashboard, an instrument panel, a vehicle infotainment console, a heads-up display, and a visor of a motor vehicle.

6. The rearview display for a vehicle of claim 1, further comprising at least a second lens in optical communication with the at least one light diverter.

7. The rearview display for a vehicle of claim 6, further comprising at least a third lens in optical communication with the second lens and the imager.

8. The rearview display for a vehicle of claim 1, further comprising at least a second light diverter in optical communication with the at least one light diverter and the imager.

9. The rearview display for a vehicle of claim 1, wherein the imager is one of a charge coupled device and a complementary metal-oxide semiconductor, and wherein the imager converts optical images to digital signals.

10. The rearview display for a vehicle of claim 1, further comprising a communication system, wherein images produced by the imaging system are transmitted through the communication system.

11. The rearview display for a vehicle of 10, wherein the imager transmits images to at least one of a receiver exterior to the vehicle and a display element in the interior of the vehicle.

12. The rearview display for a vehicle of claim 10, wherein the display element is disposed in one of a rearview assembly, an A pillar, a visor, a heads-up display, and an infotainment console of a vehicle.

13. The rearview display for a vehicle of claim 1, further comprising an image stabilizer disposed to stabilize images captured by the imaging system.

14. The rearview display for a vehicle of claim 1, wherein the housing isWa further configured to optically isolate the at least one light diverter and the imager from ambient light.

15. The rearview display for a vehicle of claim 1, further comprising at least a second light diverter in optical communication with the imager.

16. An imaging system comprising:
a first lens;
a second lens;
a first light diverter configured to direct light from the first lens to the second lens;
a third lens in optical communication with the second lens;
a second light diverter in optical communication with the third lens and configured to direct light from the second lens to the third lens;
an imager in optical communication with the second light diverter; and
a housing enclosing at least the second lens, the third lens, the first light diverter, and the second light diverter;
wherein light enters first light diverter from a first direction and is redirected to a second direction; and
wherein light enters second light diverter from a second direction and is redirected to a third direction.

17. The imaging system of claim 16, wherein the imaging system is disposed in the interior of a vehicle.

18. The imaging system of claim 16, wherein the imager receives an optical image and transforms the optical image to a digital image.

19. The imaging system of claim 17, further comprising a communication system in communication with the imager; wherein the communication system transmits an image collected by the imaging system to at least one receiver.

20. The imaging system of claim 16, wherein the first lens is disposed in one of a lip and a bezel of a rearview assembly of a vehicle.
